(19) United States
(12) Patent Application Publication
(10) Pub. No.: US 2015/0194888 A1
(43) Pub. Date: Jul. 9, 2015

(54) POWER SOURCE CIRCUIT

(71) Applicant: KABUSHIKI KAISHA TOSHIBA, Tokyo (JP)

(72) Inventors: Kei KASAI, Toshima (JP); Makoto OKADA, Ichikawa (JP)

(21) Appl. No.: 14/309,785

(22) Filed: Jun. 19, 2014

(30) Foreign Application Priority Data
Jan. 7, 2014 (JP) 2014-001069

(51) Int. Cl. H02M 3/158

(52) U.S. Cl. CPC H02M 3/158

(57) ABSTRACT

A power source circuit includes a first transistor as an output switch, a second transistor as a load switch, a reference voltage generating section, a soft start voltage generating section, a feedback voltage generating section, first and second error amplifiers, and first and second offset control sections. The first error amplifier controls a conduction state of the first transistor based on a difference between a soft start voltage obtained by adding an offset voltage to a soft start voltage or a reference voltage, whichever is smaller, and a feedback voltage. The second error amplifier controls a conduction state of the second transistor based on a difference between a soft start voltage obtained by adding an offset voltage to the soft start voltage and the feedback voltage.

### CROSS-REFERENCE TO RELATED APPLICATION

This application is based upon and claims the benefit of priority from Japanese Patent Application No. 2014-001069, filed Jan. 7, 2014, the entire contents of which are incorporated herein by reference.

### FIELD

Embodiments described herein relate to a power source circuit.

### BACKGROUND

A booster-type DC-DC converter includes a soft start circuit which suppresses an inrush current upon starting a device. The soft start circuit includes, for example, a circuit which charges a capacitor and outputs a charge voltage of the capacitor as a soft start voltage.

However, in the booster-type DC-DC converter, there is a drawback that the booster-type DC-DC converter biases an output voltage Vout through a parasitic diode between a drain and a source of an output switch on a high side and hence, soft starting may not be achieved.

### DESCRIPTION OF THE DRAWINGS

FIG. 1 is a circuit diagram illustrating an example configuration of a power source circuit according to a first embodiment.

FIG. 2 is a waveform chart illustrating an example of an output of a soft start voltage generating section.

FIG. 3A and FIG. 3B are waveform charts illustrating an example of an offset control of an error amplifier.

FIG. 4 is a waveform chart illustrating an example of an operation of the power source circuit of the first embodiment.

FIG. 5 is a circuit diagram illustrating an example configuration of a power source circuit of a second embodiment.

FIG. 6 is a circuit diagram illustrating an example configuration of an overcurrent protecting circuit.

FIG. 7 is a waveform chart illustrating an example of an operation of the overcurrent protecting circuit.

### DETAILED DESCRIPTION

Embodiments provide a power source circuit which may suppress an inrush current upon starting a device while suppressing the increase in the size of the circuit.

In general, according to one embodiment, a power source circuit includes: a first switch; a second switch; a reference voltage generating section; a soft start voltage generating section; a feedback voltage generating section; a first error amplifier; and a second error amplifier. The first switch is connected to an input power source. The second switch is connected between the first switch and an output node. The reference voltage generating section generates a reference voltage. The soft start voltage generating section generates a first soft start voltage in response to a start signal. The feedback voltage generating section generates a feedback voltage from an output voltage. The first error amplifier receives the reference voltage, a second soft start voltage obtained by adding a first offset voltage to the first soft start voltage and the feedback voltage, and controls a conduction state of the first switch based on a difference between the second soft start voltage or the reference voltage, whichever is smaller, and the feedback voltage. The second error amplifier receives a third soft start voltage obtained by adding a second offset voltage to the first soft start voltage and the feedback voltage, and controls a conduction state of the second switch based on a difference between the third soft start voltage and the feedback voltage.

Hereinafter, an exemplary embodiment of the present disclosure is explained by reference to drawings. In the drawings, identical or corresponding parts are given same symbols and the explanation of these parts is not repeated.

### First Embodiment

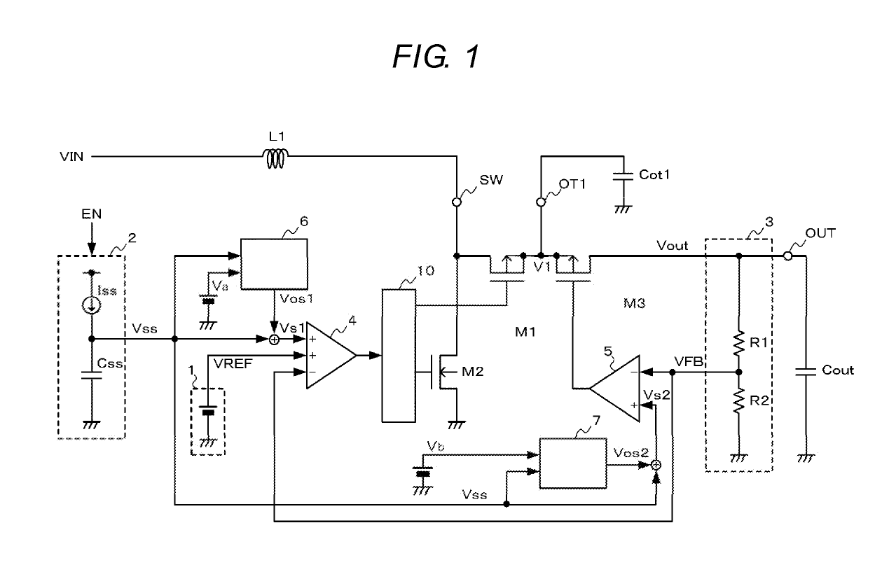

FIG. 1 is a circuit diagram illustrating an example of the constitution of a power source circuit according to a first embodiment. In the power source circuit of this embodiment, an inductor L1 connected to an input power source VIN is connected to an input terminal SW, and an output capacitor Cout is connected to an output terminal OUT. Accordingly, the power source circuit is operated as a booster-type DC-DC converter.

The power source circuit of this embodiment includes: a PMOS transistor M1 and an NMOS transistor M2 that are connected to the input terminal SW; a PMOS transistor M3 that is connected between the PMOS transistor M1 and the output terminal OUT; a reference voltage generating section 1 that generates a reference voltage VREF; a soft start voltage generating section 2 that generates a soft start voltage Vss which is gradually increased in response to inputting of a start signal EN and reaches a voltage higher than the reference voltage VREF; a feedback voltage generating section 3 that generates a feedback voltage VFB by dividing the output voltage Vout; an error amplifier 4 to which the reference voltage VREF, a soft start voltage Vs1 obtained by adding an offset voltage Vos1 to the soft start voltage Vss and the feedback voltage VFB are inputted; an error amplifier 5 to which a soft start voltage Vs2 obtained by adding an offset voltage Vos2 to the soft start voltage Vss and the feedback voltage VFB are inputted; an offset control section 6 that controls outputting of the offset voltage Vos1; and an offset control section 7 that controls outputting of the offset voltage Vos2.

The PMOS transistor M1 is an output switch, and the NMOS transistor M2 is a low-side switch that is connected between the input terminal SW and a ground terminal.

The PMOS transistor M3 is a load switch that prevents an overcurrent from flowing into the PMOS transistor M1 upon short-circuiting of a load.

A node between the PMOS transistor M1 and the PMOS transistor M3 is connected to an output terminal OT1. A capacitor Cot1 is connected to the output terminal OT1.

The reference voltage generating section 1 generates the reference voltage VREF of a constant voltage based on a band gap of silicon (Si), for example.

The soft start voltage generating section 2 includes, for example, a soft start setting capacitor Css and a current source Iss. When a start signal EN is inputted to the soft start voltage generating section 2, the supply of a charge current to the soft start setting capacitor Css from the current source Iss is started. As a result, a charge voltage of the soft start setting capacitor Css is gradually increased. This charge voltage is outputted as a soft start voltage Vss.

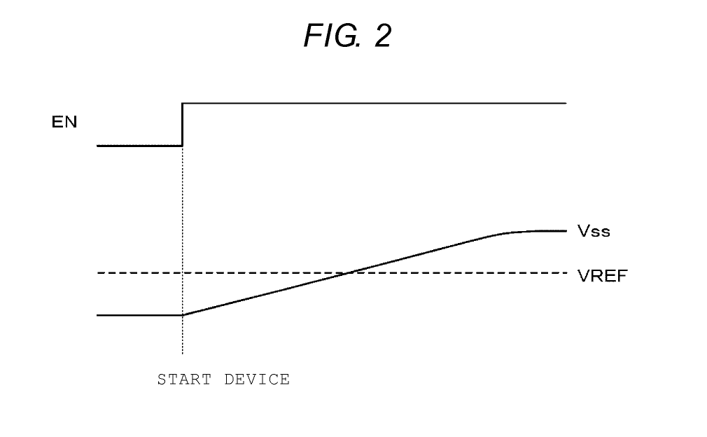

FIG. 2 illustrates a change in a soft start voltage Vss outputted from the soft start voltage generating section 2.

When the start signal EN is inputted into the soft start voltage generating section 2, the soft start voltage Vss is gradually increased and becomes higher than the reference voltage VREF at a certain point of time.

Returning to FIG. 1, the feedback voltage generating section 3 divides the output voltage Vout using resistors R1, R2 connected in series, and outputs the divided voltage as a feedback voltage VFB, for example.

Here, assuming resistance values of the resistors R1, R2 as R1, R2, respectively, and an output voltage of the output terminal OUT as Vout, a feedback voltage VFB is expressed as follows.

VFB=R2/(R1+R2)×Vout

The error amplifier 4 amplifies the difference between a soft start voltage Vs1 obtained by adding an offset voltage Vos1 to a soft start voltage Vss or a reference voltage VREF whichever is smaller and a feedback voltage VFB, and controls the conduction of the PMOS transistor M1 that constitutes an output switch and the conduction of the NMOS transistor M2 through a driving section 10.

The error amplifier 5 amplifies the difference between a soft start voltage Vs2 obtained by adding an offset voltage Vos2 to a soft start voltage Vss and a feedback voltage VFB, and controls the conduction of the PMOS transistor M3 that constitutes a load switch.

In this embodiment, the offset control section 6 outputs an offset voltage Vos1 when a soft start voltage Vss is lower than a reference voltage Va described later. In such a case, the offset voltage Vos1 is a negative voltage, and the reference voltage Va is set to satisfy the relationship of Va≧VREF+Vos1.

When the soft start voltage Vss is equal to or more than the reference voltage Va, the offset control section 6 does not output an offset voltage.

On the other hand, the offset control section 7 outputs an offset voltage Vos2 when a soft start voltage Vss is equal to or more than a reference voltage Vb described later. The offset voltage Vos2 is a positive voltage.

During a period in which a soft start voltage Vss is lower than the reference voltage Vb, the offset control section 7 does not output an offset voltage. The reference voltage Vb is set to satisfy the relationship of Vb≧VIN/(R1+R2)×R2 and the relationship of Va≧Vb.

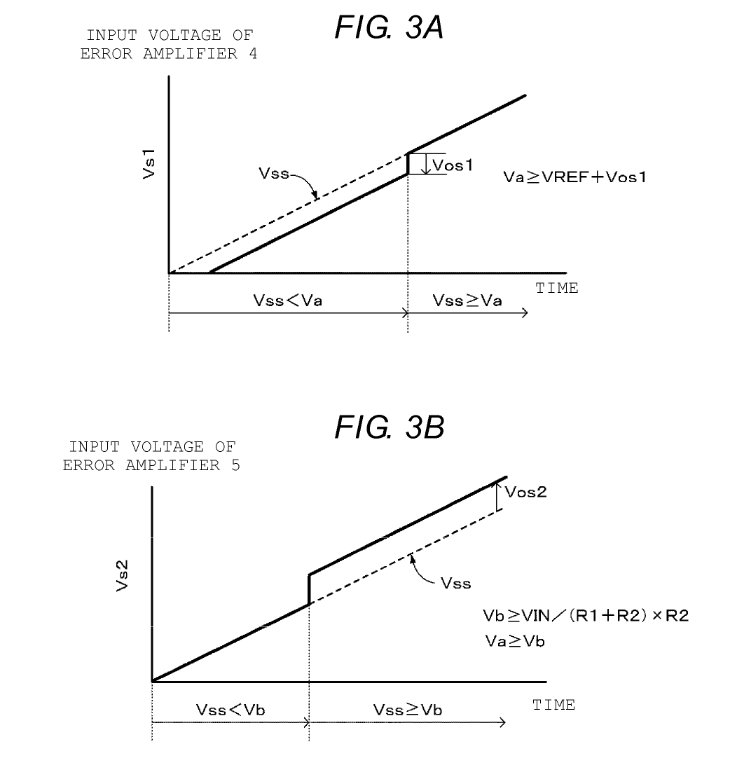

FIG. 3A and FIG. 3B illustrate examples of offset controls performed by the offset control section 6 and the offset control section 7 respectively.

FIG. 3A illustrates an example of an input offset control of the error amplifier 4 performed by the offset control section 6.

When a soft start voltage Vss is lower than the reference voltage Va, the offset control section 6 outputs an offset voltage Vos1 to a terminal of the error amplifier 4 to which the soft start voltage Vss is inputted. On the other hand, when the soft start voltage Vss is equal to or more than the reference voltage Va, the offset control section 6 does not output the offset voltage Vos1.

Accordingly, a soft start voltage Vs1 of the above-mentioned input terminal of the error amplifier 4 becomes Vss−Vos1 (Vs1=Vss−Vos1) when a soft start voltage Vss is lower than the reference voltage Va (Vss<Va), while the soft start voltage Vs1 of the above-mentioned input terminal of the error amplifier 4 becomes a soft start voltage Vss (Vs1=Vss) when the soft start voltage Vss is equal to or more than the reference voltage Va (Vss≧Va).

FIG. 3B illustrates an example of an input offset control of the error amplifier 5 performed by the offset control section 7.

When a soft start voltage Vss is equal to or more than the reference voltage Vb, the offset control section 7 outputs an offset voltage Vos2 to a terminal of the error amplifier 5 to which the soft start voltage Vss is inputted. On the other hand, when a soft start voltage Vss is lower than the reference voltage Vb, the offset control section 7 does not output the offset voltage Vos2.

Accordingly, a soft start voltage Vs2 of the above-mentioned input terminal of the error amplifier 5 becomes a soft start voltage Vss (Vs2=Vss) when the soft start voltage Vss is lower than the reference voltage Vb (Vss<Vb), while a soft start voltage Vs2 of the above-mentioned input terminal of the error amplifier 5 becomes Vss+Vos2 (Vs2=Vss+Vos2) when a soft start voltage Vss is equal to or more than the reference voltage Vb (Vss≧Vb).

In this manner, in this embodiment, two error amplifiers, that is, the error amplifier 4 and the error amplifier 5 are used, and a soft start voltage Vss common to the error amplifier 4 and the error amplifier 5 is inputted to the error amplifier 4 and the error amplifier 5. However, offset voltages that differ in polarity are set to the input terminal of the error amplifier 4 and the input terminal of the error amplifier 5 respectively and hence, the relationship of Vs1<Vs2 is established between actual soft start voltages Vs1, Vs2.

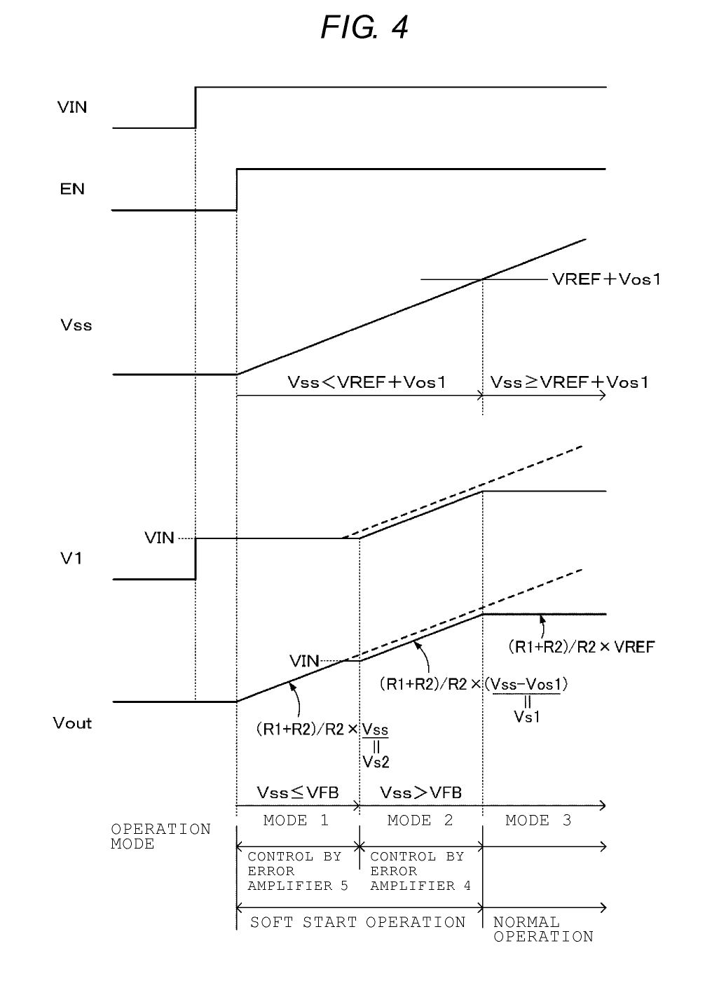

Next, the manner of operation of the power source circuit of this embodiment is explained by reference to a waveform chart illustrated in FIG. 4.

When an input voltage VIN is applied to the power source circuit and this voltage is increased, an electric current flows into the capacitor Cot1 through the inductor L1 and a parasitic diode between a drain and a source of the PMOS transistor M1. Accordingly, assuming a forward voltage of the parasitic diode as VF, an output voltage V1 of the PMOS transistor M1 is increased to approximately VIN−VF (V1≈VIN−VF).

When an electric current flows into the parasitic diode, a parasitic transistor is operated so that the electric current flows into a semiconductor substrate. Accordingly, in an actual operation, the PMOS transistor M1 is turned on after an input voltage VIN is applied to the power source circuit so that an input voltage VIN and an output voltage Vout becomes substantially equal (VIN≈V1).

At this point of time, the PMOS transistor M3 is in an OFF state and hence, an output voltage V1 of the PMOS transistor M1 is not transmitted to the output terminal OUT so that the output voltage Vout is kept at 0V.

Thereafter, when a start signal EN is inputted to the soft start voltage generating section 2, the soft start voltage generating section 2 starts the operation thereof thus outputting a soft start voltage Vss. The error amplifier 4 and the error amplifier 5 start operating in response to the soft start voltage Vss.

An operation mode of the power source circuit after the soft start voltage Vss is outputted is, based on the magnitude relationship between a soft start voltage Vss and a reference voltage VREF, roughly classified into a soft start operation mode which is performed when the soft start voltage Vss is smaller than the reference voltage VREF (Vss<VREF) and a usual operation mode which is performed when the soft start voltage Vss is equal to or more than the reference voltage VREF (VssVREF).

In this embodiment, the soft start operation mode is further classified into two additional operation modes based on the magnitude relationship between a soft start voltage Vss and a feedback voltage VFB. Accordingly, there exist three operation modes. In this embodiment, the soft start operation mode is divided into two modes referred to as a mode 1 and a mode 2, and the usual operation mode is referred to as a mode 3.

Next, these three operation modes are explained.

### (Mode 1)

The mode 1 is an operation mode adopted during a period immediately after outputting of a soft start voltage Vss is started, that is, during a period where a soft start voltage Vss is smaller than the reference voltage VREF (Vss<VREF) and the soft start voltage Vss is equal to or smaller than a feedback voltage VFB (VssVFB).

During this period, the soft start voltage Vss is smaller than the reference voltage VREF (Vss<VREF) and hence, an offset voltage Vos1 is outputted from the offset control section 6 so that a soft start voltage Vs1 inputted to the error amplifier 4 becomes Vss−Vos1 (Vs1=Vss−Vos1). The soft start voltage Vs1 is lower than the reference voltage VREF and hence, the error amplifier 4 compares the soft start voltage Vs1 with the feedback voltage VFB.

At this point of time, the feedback voltage VFB is larger than the soft start voltage Vs1 and hence, the error amplifier 4 performs a control such that the PMOS transistor M2 of the output switch is turned off. As a result, an output voltage V1 of the PMOS transistor M1 is kept at an input voltage VIN.

On the other hand, an offset voltage is not set by the offset control section 7 during this period and hence, a soft start voltage Vs2 inputted to the error amplifier 5 becomes a soft start voltage Vss (Vs2=Vss).

Accordingly, the error amplifier 5 compares the soft start voltage Vs2, that is, the soft start voltage Vss with the feedback voltage VFB, and controls the conduction of the PMOS transistor M3 such that the feedback voltage VFB agrees with the soft start voltage Vss.

As a result, an output voltage Vout outputted from the PMOS transistor M3 is increased in response to the increase of the soft start voltage Vss. The output voltage Vout at this point of time is expressed by the following formula.

Vout=(R1+R2)/R2×Vss

The increase of the output voltage Vout continues until the output voltage Vout reaches an input voltage VIN that is an input voltage of the PMOS transistor M3.

In this manner, in the mode 1, even when the output voltage V1 of the PMOS transistor M1 is increased to the input voltage VIN immediately after outputting of the soft start voltage Vss is started, the error amplifier 5 performs a control such that an output voltage Vout is gradually increased.

### (Mode 2)

The mode 2 is an operation mode adopted during a period where a soft start voltage Vss is smaller than a reference voltage VREF (Vss<VREF) and the soft start voltage Vss is larger than a feedback voltage VFB (Vss>VFB).

During this period, a boosting operation is started by the error amplifier 4, and the error amplifier 4 controls the conduction of the PMOS transistor M1 such that a feedback voltage VFB agrees with a soft start voltage Vs1.

During this period, since the error amplifier 5 does not have a boosting function, the PMOS transistor M3 outputs an output voltage V1 of the PMOS transistor M1 without any change. Accordingly, the output voltage Vout of the output terminal OUT becomes the output voltage V1 (Vout=V1).

Accordingly, the output voltage Vout is expressed by the following formula.

$$\begin{matrix}Vout = ( R 1 + R 2 ) / R 2 \times Vs 1 \\ = ( R 1 + R 2 ) / R 2 \times ( Vss - Vos 1 )\end{matrix}$$

In this manner, in the mode 2, a control where an output voltage is gradually increased is performed by the error amplifier 4.

### (Mode 3)

In the mode 3, a soft start operation is finished when a soft start voltage Vss becomes larger than VREF+Vos1 (Vss>VREF+Vos1), and a usual operation mode is started.

In the mode 3, a soft start voltage Vs1 becomes larger than a reference voltage VREF (Vs1>VREF), and a reference voltage for setting an output voltage Vout becomes a reference voltage VREF.

A soft start voltage Vs1 which is inputted to the error amplifier 4 becomes Vss−Vos1 (Vs1=Vss−Vos1) when the soft start voltage Vss is smaller than a reference voltage Va (Vss<Va), while the soft start voltage Vs1 becomes a soft start voltage Vss (Vs1=Vss) when the soft start voltage Vss is larger than the reference voltage Va (Vss>Va). In both cases, a soft start voltage Vs1 which is inputted to the error amplifier 4 is larger than the reference voltage VREF (Vs1>VREF) so that a reference voltage for setting an output voltage Vout becomes the reference voltage VREF.

As a result, the error amplifier 4 controls the conduction of the PMOS transistor M1 such that a feedback voltage VFB is the same with the reference voltage VREF.

Accordingly, the output voltage Vout is expressed by the following formula so that the output voltage Vout is not influenced by the presence or the non-presence of the offset voltage Vos1.

Vout=(R1+R2)/R2×VREF

An offset voltage Vos2 is outputted to the error amplifier 5 from the offset control section 7 so that a soft start voltage Vs2 which is inputted to the error amplifier 5 becomes a voltage expressed by the following formula, whereby the PMOS transistor M3 maintains an ON state.

Vs2=Vss+Vos2

According to this embodiment, a common soft start voltage Vss generated by the common soft start voltage generating section 2 is supplied to the error amplifier 5 that controls the conduction of the PMOS transistor M3 that constitutes a load switch and the error amplifier 4 that controls the conduction of the PMOS transistor M1 that is an output switch. Accordingly, it is possible to suppress an inrush current upon starting a device while suppressing the increase in the size of the circuit.

Further, offset voltages having different polarities may be set to the error amplifiers 4, 5 that share a soft start operation and hence, even when two error amplifiers have different properties, it is possible to prevent operation regions of two error amplifiers from overlapping with each other so that a stable soft start operation may be performed.

### Second Embodiment

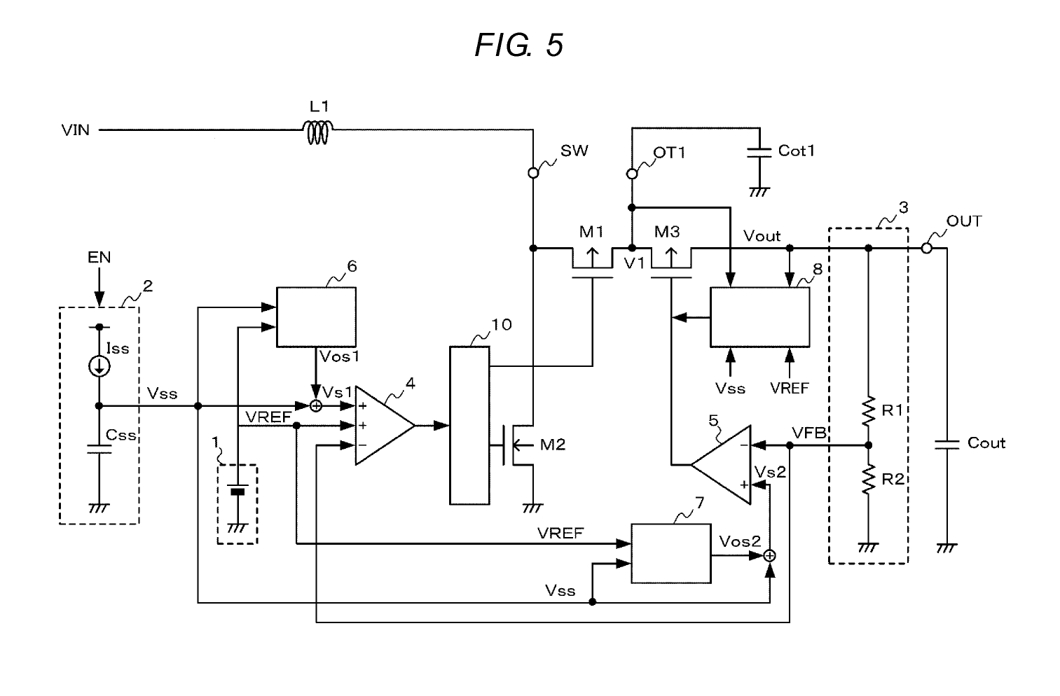

FIG. 5 is a circuit diagram illustrating an example of the constitution of a power source circuit of a second embodiment.

The power source circuit of this embodiment is obtained by adding an overcurrent protecting circuit 8 to the power source circuit of the first embodiment.

The overcurrent protecting circuit 8 monitors an electric current flowing into a PMOS transistor M3 that constitutes a load switch, and prevents an overcurrent from flowing into the PMOS transistor M3 upon performing a soft start operation by controlling the conduction of the PMOS transistor M3.

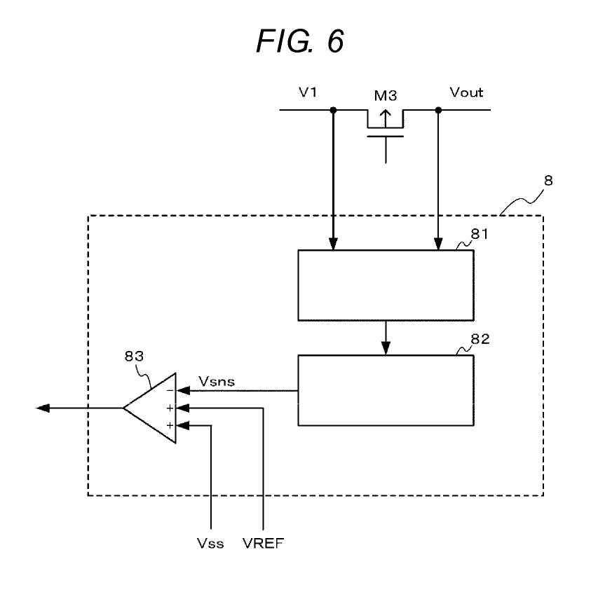

FIG. 6 is a circuit diagram illustrating an example of the internal configuration of the overcurrent protecting circuit 8.

The overcurrent protecting circuit 8 includes: a current detection section 81 that detects an electric current flowing into the PMOS transistor M3; a current-voltage conversion section 82 that performs current-voltage conversion of the electric current detected by the current detection section 81 and outputs a detection voltage Vsns; and an error amplifier 83 that controls the conduction of the PMOS transistor M3 corresponding to the difference between a soft start voltage Vss or a reference voltage VREF whichever is smaller and the detection voltage Vsns.

When a soft start voltage Vss is smaller than the reference voltage VREF (Vss<VREF), the error amplifier 83 controls the conduction of the PMOS transistor M3 corresponding to the difference between the soft start voltage Vss and the detection voltage Vsns. Accordingly, an output current Iout which flows into the PMOS transistor M3 is increased in response to the increase of the soft start voltage Vss.

On the other hand, when a soft start voltage Vss is equal to or more than the reference voltage VREF (Vss≧VREF), the error amplifier 83 controls the conduction of the PMOS transistor M3 corresponding to the difference between the reference voltage VREF and the detection voltage Vsns. Accordingly, an output current Iout that flows into the PMOS transistor M3 is controlled to a constant current or a limit current Ioc.

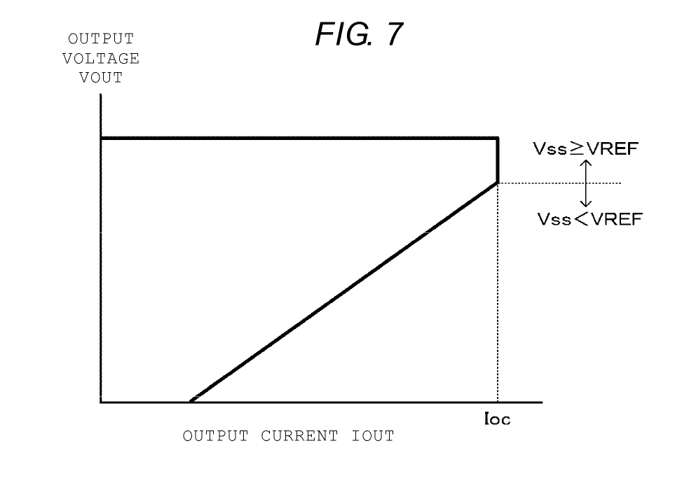

FIG. 7 illustrates an example of a control of an output current Iout performed by the overcurrent protecting circuit 8.

An output voltage Vout and an output current Iout have the relationship where the output current Iout is increased along with the increase of the output voltage Vout during a period where the soft start voltage Vss is smaller than the reference voltage VREF (Vss<VREF), and the output current Iout is limited to a limit current Ioc when the soft start voltage Vss becomes equal to or more than the reference voltage VREF. That is, the relationship between the output voltage Vout and the output current bout exhibits a characteristic expressed by the character V, the point of which is directed to the right.

According to this embodiment, even when a capacitor of large capacity is connected to an output terminal OUT as an output capacitor Cout so that a soft start time set by an inner circuit is insufficient upon performing a soft start operation, an inrush current may be decreased.

According to the power source circuit of any one of the above-explained embodiments, it is possible to suppress an inrush current upon starting a device while suppressing the increase of a scale of circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power source circuit comprising:
a first switch connected to an input power source;
a second switch connected between the first switch and an output node;
a reference voltage generating section configured to generate a reference voltage;
a soft start voltage generating section configured to generate a first soft start voltage in response to a start signal;
a feedback voltage generating section configured to generate a feedback voltage from an output voltage at the output node;
a first error amplifier configured to receive the reference voltage, a second soft start voltage obtained by adding a first offset voltage to the first soft start voltage and the feedback voltage, and amplify a difference between the second soft start voltage or the reference voltage, whichever is smaller, and the feedback voltage to generate a control signal for the first switch; and
a second error amplifier configured to receive a third soft start voltage obtained by adding a second offset voltage to the first soft start voltage and the feedback voltage, and amplify a difference between the third soft start voltage and the feedback voltage to generate a control signal for the second switch.

2. The power source circuit according to claim 1, wherein the feedback voltage is generated by dividing the output voltage.

3. The power source circuit according to claim 1, wherein the first switch is a transistor having a gate that is connected to the first error amplifier to receive the control signal generated by the first error amplifier.

4. The power source circuit according to claim 3, wherein the second switch is a transistor having a gate that is connected to the second error amplifier to receive the control signal generated by the second error amplifier.

5. The power source circuit according to claim 1, further comprising:
a first offset control section configured to output a first voltage as the first offset voltage when the first soft start voltage is lower than the reference voltage and a zero voltage as the first offset voltage when the first soft start voltage is equal to or higher than the reference voltage, and
a second offset control section configured to output a second voltage as the second offset voltage when the first soft start voltage is equal to or higher than the reference voltage and a zero voltage as the second offset voltage when the first soft start voltage is less than the reference voltage.

6. The power source circuit according to claim 5, wherein
the first voltage is a negative voltage, and
the second voltage is a positive voltage.

7. The power source circuit according to claim 1, further comprising:
an overcurrent protecting circuit configured to control a conduction state of the second switch in accordance with a difference between the first soft start voltage or the reference voltage, whichever is smaller, and a detection voltage obtained by detecting an electric current flowing into the second switch and converting the detected electric current into the detection voltage.

8. The power source circuit according to claim 7, wherein
the overcurrent protecting circuit is configured to control the conduction state of the second switch such that the electric current flowing into the second switch is proportional to the output voltage when the first soft start voltage is lower than the reference voltage.

9. A power source circuit comprising:
a first transistor connected to an input power source;
a second transistor connected between the first transistor and an output node;
a reference voltage generating section configured to generate a reference voltage;
a soft start voltage generating section configured to generate a first soft start voltage in response to a start signal;
a feedback voltage generating section configured to generate a feedback voltage from an output voltage at the output node;
a first error amplifier configured to generate a control signal supplied to a gate of the first transistor from a difference between the feedback voltage and a smaller one of the reference voltage and a second soft start voltage obtained by adding a first offset voltage to the first soft start voltage; and
a second error amplifier configured to generate a control signal supplied to a gate of the second transistor from a difference between the feedback voltage and a third soft start voltage obtained by adding a second offset voltage to the first soft start voltage.

10. The power source circuit according to claim 9, further comprising:
an overcurrent protecting circuit configured to control a conduction state of the second transistor such that the electric current flowing into the second transistor is maintained below a threshold level.

11. The power source circuit according to claim 10, wherein the overcurrent protecting circuit is configured to control the conduction state of the second transistor such that the electric current flowing into the second transistor is proportional to the output voltage when the first soft start voltage is lower than the reference voltage.

12. The power source circuit according to claim 11, wherein the feedback voltage is generated by dividing the output voltage.

13. The power source circuit according to claim 11, further comprising:
a first offset control section configured to output a first voltage as the first offset voltage when the first soft start voltage is lower than the reference voltage and a zero voltage as the first offset voltage when the first soft start voltage is equal to or higher than the reference voltage, and
a second offset control section configured to output a second voltage as the second offset voltage when the first soft start voltage is equal to or higher than the reference voltage and a zero voltage as the second offset voltage when the first soft start voltage is less than the reference voltage.

14. The power source circuit according to claim 13, wherein
the first and second voltages have opposite polarities.

15. A method of generating an output current and an output voltage in a power source circuit having a first switch connected to an input power source and a second switch connected between the first switch and an output node, comprising;
generating a first soft start voltage in response to a start signal;
generate a feedback voltage from an output voltage at the output node;
generating a first control signal, which is supplied to the first switch, from a difference between the feedback voltage and a smaller one of the reference voltage and a second soft start voltage obtained by adding a first offset voltage to the first soft start voltage; and
generating a second control signal, which is supplied to the second switch, from a difference between the feedback voltage and a third soft start voltage obtained by adding a second offset voltage to the first soft start voltage.

16. The method according to claim 15, wherein the feedback voltage is generated by dividing the output voltage.

17. The method according to claim 15, further comprising:
generating a first voltage as the first offset voltage when the first soft start voltage is lower than the reference voltage and a zero voltage as the first offset voltage when the first soft start voltage is equal to or higher than the reference voltage, and
generating a second voltage as the second offset voltage when the first soft start voltage is equal to or higher than the reference voltage and a zero voltage as the second offset voltage when the first soft start voltage is less than the reference voltage.

18. The method according to claim 17, wherein the first and second voltages have opposite polarities.

19. The method according to claim 15, further comprising:
controlling a conduction state of the second transistor such that the electric current flowing into the second transistor is maintained below a threshold level.

20. The method according to claim 19, further comprising:
controlling a conduction state of the second transistor such that the electric current flowing into the second transistor is proportional to the output voltage when the first soft start voltage is lower than the reference voltage.
